(19) United States
(12) Patent Application Publication
(10) Pub. No.: US 2026/0212687 A1
(43) Pub. Date: Jul. 23, 2026

(54) ROAD SURFACE MARKING IDENTIFICATION METHOD AND ROAD SURFACE MARKING IDENTIFICATION DEVICE

(71) Applicant: Nissan Motor Co., Ltd., Yokohama-shi, Kanagawa (JP)

(72) Inventors: He LIU, Kanagawa (JP); Hirotoshi UEDA, Kanagawa (JP)

(21) Appl. No.: 19/140,386

(22) PCT Filed: Dec. 21, 2022
(86) PCT No.: PCT/JP2022/047215

§ 371 Date: Jun. 18, 2025

(51) Int. Cl. G06V 20/56; G06V 10/44; G06V 10/56; G06V 10/82

(52) U.S. Cl. CPC G06V 20/588; G06V 10/44; G06V 10/56; G06V 10/82

(57) ABSTRACT

A road surface marking identification method and a road surface marking identification device identify a road surface marking appearing in a first image captured by an imager. First machine learning is performed using a first convolutional neural network to learn a relationship between color information of the first image and a first label. Second machine learning is performed using a second convolutional neural network to learn the relationship between shape information of the first image and the first label. A convolution operation is selected for each pixel constituting the convolutional layer of one of the first and second convolutional neural networks based on an output value for each pixel constituting the convolutional layer of the other during the first machine learning and the second machine learning. The road surface marking is identified using at least one of the first and second convolutional neural networks.

### CROSS-REFERENCE TO RELATED APPLICATIONS

This application is a U.S. national stage application of International Application No. PCT/JP2022/047215, filed on Dec. 21, 2022.

### BACKGROUND

### Technical Field

The present invention relates to a road surface marking identification method and a road surface marking identification device.

### Background Information

An intelligent drive control method has been proposed which detects the driving environment of a vehicle, obtains detection results for at least one category of target objects in the driving environment, triggers driving warnings based on the detection results depending on whether the detection results satisfy predetermined driving warning conditions and whether the vehicle's traveling speed exceeds a speed threshold, thereby improving the safety of vehicle travel while limiting the number of warnings with lower danger levels and/or lower urgency levels via the speed threshold (see Japanese Unexamined Patent Application Publication No. 2021-504245 hereinafter referred to as Patent Literature 1).

### SUMMARY

According to the Patent Literature 1, multiple types of lanes are recognized using a convolutional neural network based on images capturing the surroundings of a vehicle. However, due to the convolutional calculations in the convolutional neural network, there is significant information loss in elongated regions within the image. Consequently, there is a problem of easily misrecognizing traffic signs such as unclear traffic signs or distant color-differentiated lanes.

The present invention has been made in view of the above problem. Its objective is to provide a road surface marking identification method and a road surface marking identification device that can suppress information loss in elongated regions in images when recognizing traffic signs appearing in images using a convolutional neural network, and can suppress misrecognition of traffic signs such as unclear traffic signs or distant color-differentiated lanes.

To solve the above problem, a road surface marking identification method and a road surface marking identification device according to one aspect of the present invention identify a road surface marking appearing in a first image captured by an imaging unit mounted on a vehicle of surroundings of the vehicle, perform first machine learning using a first convolutional neural network to learn a relationship between color information of the first image and a first label, perform second machine learning using a second convolutional neural network to learn the relationship between shape information of the first image and the first label, select the convolution operation for each pixel constituting the convolutional layer of one of the first convolutional neural network and the second convolutional neural network based on the output value for each pixel constituting the convolutional layer of the other during the first machine learning and the second machine learning, and identify the road surface marking using at least one of the first convolutional neural network and the second convolutional neural network.

According to the present invention, in the recognition of traffic signs appearing in images using a convolutional neural network, information loss in elongated regions within the image can be suppressed, and misrecognition of traffic signs such as unclear traffic signs or distant color-differentiated lanes can be suppressed.

### BRIEF DESCRIPTION OF DRAWINGS

Referring now to the attached drawings which form a part of this original disclosure, illustrative embodiments are shown.

FIG. 1 is a block diagram showing the configuration of a road surface marking identification device according to one embodiment of the present invention.

FIG. 2 is a flowchart showing a processing example of the road surface marking identification device according to one embodiment of the present invention.

FIG. 3 is a block diagram showing the configuration of convolutional neural networks in the road surface marking identification device according to one embodiment of the present invention.

FIG. 4A is a diagram showing an example of an image captured of the surroundings of a vehicle.

FIG. 4B is a diagram showing an example of shape information generated based on an image.

FIG. 4C is a diagram showing an example of the distribution of labels set for each pixel.

FIG. 4D is a diagram showing a reference example of the distribution of labels set for each pixel.

### DETAILED DESCRIPTION OF EMBODIMENTS

Next, embodiments of the present invention will be described in detail with reference to the drawings. In the description, the same components are given the same reference numerals to avoid duplicate explanations.

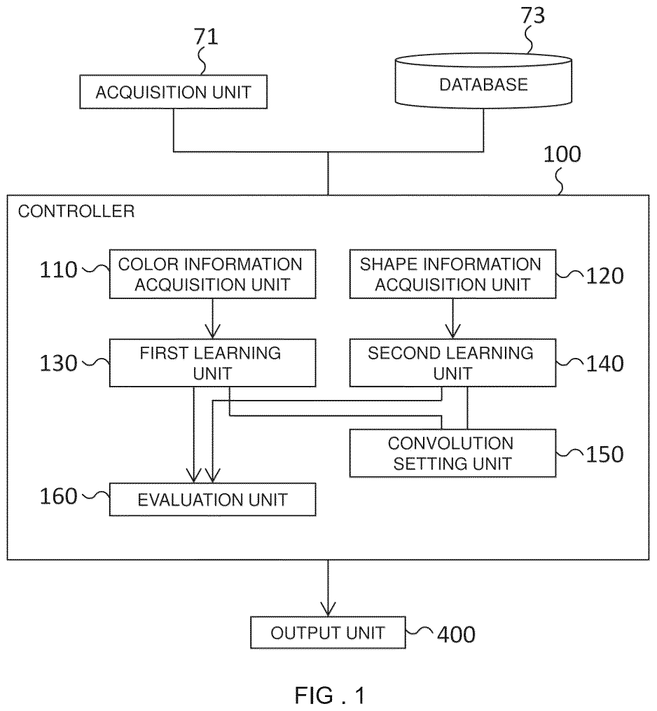

FIG. 1 is a block diagram showing the configuration of a road surface marking identification device according to the present embodiment. As shown in FIG. 1, the road surface marking identification device according to the present embodiment includes an acquisition unit 71, a database 73, a controller 100, and an output unit 400. The controller 100 is connected to the acquisition unit 71, the database 73, and the output unit 400 via wired or wireless communication paths.

The acquisition unit 71 acquires training data to be used for machine learning (or deep learning) in the controller 100. In particular, the acquisition unit 71 acquires “teaching label images” as training data. A “teaching label image” is an image in which a first label that identifies road surface markings appearing in the first image is assigned to each pixel constituting the first image, where the first image is captured by an imaging unit (such as a camera) mounted on a vehicle of the area in front of the vehicle.

Various road surface markings can be identified by the first label. Road surface markings may include “white solid line,” “white broken line,” “stop line,” “pedestrian crossing,” “zebra crossing,” “arrow,” “bicycle navigation line,” “blue solid line,” “yellow solid line,” “other” that does not fall into any of the above categories, and various others. Among the road surface markings, “arrow” may include “within intersection,” “straight ahead and left turn,” “left turn,” “straight ahead,” “right turn,” “straight ahead and right turn,” and others. Road surface markings are not limited to the examples listed here.

The teaching label images may be generated by “annotation,” where a person visually confirms the first image and assigns a first label to each pixel constituting the first image. Furthermore, the teaching label images may be generated by performing viewpoint transformations on teaching label images generated by “annotation” based on possible virtual poses that the imaging unit could take. That is, the teaching label images may be obtained by “augmenting” the teaching label images generated by “annotation.”

The teaching label images acquired by the acquisition unit 71 are input to the controller 100 and the database 73. Additionally, the acquisition unit 71 may also acquire a second image captured by the imaging unit of the surroundings of the vehicle.

The database 73 stores the teaching label images. It may also store various information generated by the controller 100. For example, the database 73 may store the learning models described later.

The output unit 400 outputs various information generated by the controller 100. For example, the output unit 400 may output the output from the learning models described later to the outside.

The controller 100 (an example of a control unit or processing unit) is a general-purpose computer including a CPU (central processing unit), memory, and input/output unit. Computer programs (information processing programs) are installed in the controller 100 to function as part of the road surface marking identification device. By executing the computer programs, the controller 100 functions as multiple information processing circuits (110, 120, 130, 140, 150, 160) that the road surface marking identification device includes.

Here, an example is shown where the multiple information processing circuits (110, 120, 130, 140, 150, 160) of the road surface marking identification device are implemented through software. However, it is also possible to prepare dedicated hardware to execute each information processing and configure the information processing circuits (110, 120, 130, 140, 150, 160). Additionally, the multiple information processing circuits (110, 120, 130, 140, 150, 160) may be configured with individual hardware.

The controller 100 includes, as multiple information processing circuits (110, 120, 130, 140, 150, 160), a color information acquisition unit 110, a shape information acquisition unit 120, a first learning unit 130, a second learning unit 140, a convolution setting unit 150, and an evaluation unit 160.

The color information acquisition unit 110 acquires color information for each pixel constituting the first image based on the first image from the teaching data, which is the teaching label image.

For example, if the first image is a color image, the color information for each pixel includes information on the luminance of red (“R”), green (“G”), and blue (“B”) at that pixel. Alternatively, if the first image is a black and white grayscale image, the color information for each pixel may be a grayscale indicating the light intensity at that pixel. The color information for each pixel is determined based on the output from imaging elements such as CCDs (charge-coupled devices) or CMOS (complementary metal oxide semiconductor) mounted on the imaging unit.

The shape information acquisition unit 120 acquires shape information for each pixel constituting the first image based on the first image from the teaching data, which is the teaching label image.

The shape information may include edge information of road surface markings appearing in the first image. The shape information acquisition unit 120 may generate edge information by applying a Sobel filter to the first image. Here, a Sobel filter is a spatial filter used in the field of image processing to detect the contours of images contained in an image. Alternatively, the shape information acquisition unit 120 may generate edge information using smoothing filters, differential filters, Prewitt filters, or combinations of these filters.

The shape information may include corner information of road surface markings appearing in the first image. The shape information acquisition unit 120 may generate corner information by applying a Harris filter to the first image. Here, a Harris filter is a spatial filter used in the field of image processing to detect corners of images contained in an image.

The first learning unit 130 performs first machine learning using a first convolutional neural network N1 consisting of multiple convolutional layers. The first learning unit 130 performs first machine learning so that, for each pixel, the first label is output from the first convolutional neural network N1 to which color information is input. As a result of the first machine learning by the first learning unit 130, parameters defining the first convolutional neural network N1 are set.

The second learning unit 140 performs second machine learning using a second convolutional neural network N2 consisting of multiple convolutional layers. The number of convolutional layers in the second convolutional neural network N2 is the same as the number of convolutional layers in the first convolutional neural network N1. Also, the size of each convolutional layer in the second convolutional neural network N2 is the same as the size of each convolutional layer in the first convolutional neural network N1. The second learning unit 140 performs second machine learning so that, for each pixel, the first label is output from the second convolutional neural network N2 to which shape information is input. As a result of the second machine learning by the second learning unit 140, parameters defining the second convolutional neural network N2 are set.

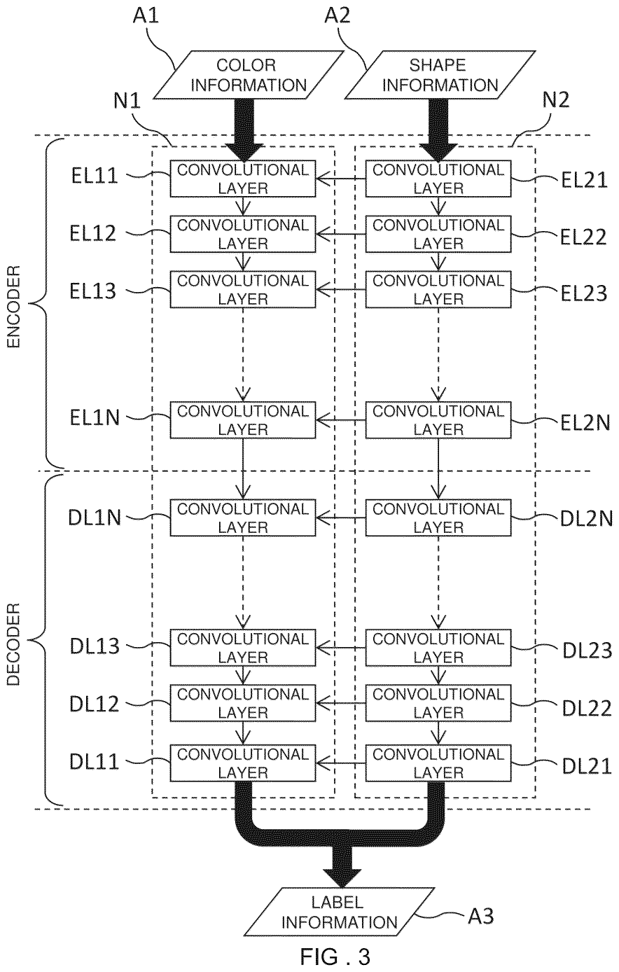

The configurations of the first convolutional neural network N1 and the second convolutional neural network N2 are shown in FIG. 3. FIG. 3 is a block diagram showing the configuration of convolutional neural networks in the road surface marking identification device according to the present embodiment.

As shown in FIG. 3, the first convolutional neural network N1 consists of “2×N” convolutional layers EL11-EL1N, DL11-DL1N. Here, N is an integer of 1 or greater. The convolutional layers EL11-EL1N, DL11-DL1N each consist of multiple units. Additionally, the first convolutional neural network N1 may include pooling layers, batch normalization layers, Rectified Linear Unit layers, upsampling layers, softmax output layers, and others.

Units between the convolutional layers EL11-EL1N, DL11-DL1N are connected. More specifically, in the first convolutional neural network N1, multiple convolutional layers are arranged in the order of EL11, EL12, EL13, . . . , ELiN, DLIN, . . . , DL13, DL12, DL11, and units in adjacently arranged convolutional layers are connected.

The set of signals that a convolutional layer of interest receives from adjacently arranged convolutional layers through the connection of units can be viewed as an “image.” Signals are processed in the order of convolutional layers EL11, EL12, EL13, . . . , EL1N, DL1N, . . . , DL13, DL12, DL11, and “images” processed in the order of the above convolutional layers can be viewed as being sequentially transmitted. Therefore, the units constituting each convolutional layer can be viewed as pixels of “images” input and output to and from each convolutional layer (in the following, “units” and “pixels” may be used interchangeably in some cases).

Each unit has an activation function (e.g., sigmoid function, rectified linear function, softmax function, etc.). A weighted sum is calculated based on multiple inputs to the unit, and the value of the activation function with the sum as a variable becomes the output of the unit. For example, in the first machine learning, weights used to calculate the sum at each unit of the first convolutional neural network N1 are adjusted as parameters defining the first convolutional neural network N1.

Among the first convolutional neural network N1, convolutional layers EL11-EL1N constitute an encoder and generate a low-dimensional latent representation related to the set of color information A1 (the set of color information for all pixels constituting the first image) input. Also, convolutional layers DL11-DL1N constitute a decoder and generate a set of label information A3 from the low-dimensional latent representation.

Through the first machine learning, the first convolutional neural network N1 becomes a learning model that expresses the relationship between color information assigned to each pixel constituting the first image and the first label for each first image.

As shown in FIG. 3, the second convolutional neural network N2 consists of “2×N” convolutional layers EL21-EL2N, DL21-DL2N. Here, N is an integer of 1 or greater. The convolutional layers EL21-EL2N, DL21-DL2N each consist of multiple units. Additionally, the second convolutional neural network N2 may include pooling layers, batch normalization layers, Rectified Linear Unit layers, upsampling layers, softmax output layers, and others.

Units between the convolutional layers EL21-EL2N, DL21-DL2N are connected. More specifically, in the second convolutional neural network N2, multiple convolutional layers are arranged in the order of EL21, EL22, EL23, . . . , EL2N, DL2N, . . . , DL23, DL22, DL21, and units in adjacently arranged convolutional layers are connected.

The set of signals that a convolutional layer of interest receives from adjacently arranged convolutional layers through the connection of units can be viewed as an “image.” Signals are processed in the order of convolutional layers EL21, EL22, EL23, . . . , EL2N, DL2N, . . . , DL23, DL22, DL21, and “images” processed in the order of the above convolutional layers can be viewed as being sequentially transmitted. Therefore, the units constituting each convolutional layer can be viewed as pixels of “images” input and output to and from each convolutional layer (in the following, “units” and “pixels” may be used interchangeably in some cases).

Each unit has an activation function (e.g., sigmoid function, rectified linear function, softmax function, etc.). A weighted sum is calculated based on multiple inputs to the unit, and the value of the activation function with the sum as a variable becomes the output of the unit. For example, in the second machine learning, weights used to calculate the sum at each unit of the second convolutional neural network N2 are adjusted as parameters defining the second convolutional neural network N2.

Among the second convolutional neural network N2, convolutional layers EL21-EL2N constitute an encoder and generate a low-dimensional latent representation related to the set of shape information A2 (the set of shape information for all pixels constituting the first image) input. Also, convolutional layers DL21-DL2N constitute a decoder and generate a set of label information A3 from the low-dimensional latent representation.

Through the second machine learning, the second convolutional neural network N2 becomes a learning model that expresses the relationship between shape information assigned to each pixel constituting the first image and the first label for each first image.

When generating learning models by performing first machine learning and second machine learning, color information or shape information is input to the input layer of the neural network constituting the learning model, and sets of probabilities indicated for each label are output from the output layer. In the sets of probabilities indicated for each label, the parameters of the learning model are adjusted so that the probability for the first label is maximized. Alternatively, when a label is output from the output layer when color information or shape information is input to the input layer, the parameters of the first convolutional neural network N1 and the second convolutional neural network N2 are adjusted so that the difference between the output label and the first label is minimized.

When generating learning models by performing first machine learning and second machine learning, gradient descent methods, stochastic gradient descent methods, and others may be used to minimize the error related to the output of the neural network. Additionally, backpropagation may be used for gradient calculations in gradient descent methods and stochastic gradient descent methods.

In machine learning using neural networks, generalization performance (the ability to discriminate unknown data) and overfitting (a phenomenon where the model fits the data used to create the learning model, but generalization performance does not improve) can be problematic.

Therefore, when generating learning models by performing first machine learning and second machine learning, techniques such as regularization, which constrain the degrees of freedom of weights during learning, may be used to mitigate overfitting. Other techniques such as dropout, which probabilistically selects units in the neural network and disables other units, may also be used. Furthermore, techniques such as data regularization, data standardization, and data augmentation, which eliminate biases in the data, may be used to improve generalization performance.

The convolution setting unit 150, during the first machine learning and the second machine learning, selects the convolution operation for each pixel constituting the convolutional layer of the first convolutional neural network based on the output value for each pixel constituting the convolutional layer of the second convolutional neural network. Similarly, the convolution setting unit 150, during the first machine learning and the second machine learning, selects the convolution operation for each pixel constituting the convolutional layer of the second convolutional neural network based on the output value for each pixel constituting the convolutional layer of the first convolutional neural network.

First, the “convolution operation” will be explained. Suppose that the “image” that a convolutional layer CL1 of interest, among the multiple convolutional layers constituting the first convolutional neural network N1 or the second convolutional neural network N2, receives from an adjacent convolutional layer CL2 consists of a set of signals of “W1×W2”. The values of the signals contained in that “image” are denoted by xᵢⱼ (where i=0,1, . . . , W1−1, j=0,1, . . . , W2−1).

On the other hand, to define the convolution operation, a “filter” consisting of a set of signals of “H1×H2” is considered. The size of that “filter” (the “filter size”) is “H1×H2”. The values of the signals contained in that “filter” are denoted by h_{pq} (where p=0,1, . . . , H1-1, q=0,1, . . . , H2-1). “H1×H2” is an integer of 2 or greater.

In this case, the convolution operation “uᵢⱼ” is defined by the following Equation 1 between the above “image” and “filter”.

$${u}_{ij} = {\sum }_{p = 0}^{H 1 - 1} {\sum }_{q = 0}^{H 2 - 1} {x}_{i + p , j + q} {h}_{pq} \qquad [ Equation 1 ]$$

That is, each unit of the convolutional layer CL1 of interest is connected to “H1×H2” units of the adjacent convolutional layer CL2. The values “h_{pq}” defining the “filter” for each unit are parameters defining the convolutional neural network (the first convolutional neural network N1 or the second convolutional neural network N2) to which the convolutional layer CL1 belongs.

The convolution setting unit 150 selects the convolution operation for each unit of the convolutional layer of the first convolutional neural network N1 based on the output value of each unit of the convolutional layer of the second convolutional neural network N2. For example, the convolution setting unit 150 selects the convolution operation for each unit of the convolutional layer ELi1 of the first convolutional neural network N1 based on the output value of each unit of the convolutional layer EL21 of the second convolutional neural network N2.

Similarly, the convolution operations for each unit constituting the convolutional layers EL12, EL13, . . . , EL1N, DL1N, . . . , DL13, DL12, DL11 are selected based on the output values of each unit constituting the convolutional layers EL22, EL23, . . . EL2N, DL2N, . . . , DL23, DL22, DL21, respectively.

For example, the convolution setting unit 150, during the first machine learning and the second machine learning, performs convolution with a filter size of 1 at units of the convolutional layer of the first convolutional neural network N1 corresponding to units of the convolutional layer of the second convolutional neural network N2 that have output values equal to or greater than a predetermined threshold.

This will be explained in more detail. Consider the case where the output of a unit of the convolutional layer of the second convolutional neural network N2, the convolution operation “uᵢⱼ”, is equal to or greater than a predetermined threshold. In this case, the output “uᵢⱼ” of the unit of the convolutional layer of the first convolutional neural network N1 corresponding to that unit may be determined as “xᵢⱼ” or a constant multiple thereof, instead of being determined by Equation 1.

On the other hand, if the output of a unit of the convolutional layer of the second convolutional neural network N2, the convolution operation “uᵢⱼ”, is less than the predetermined threshold, the output “uᵢⱼ” of the unit of the convolutional layer of the first convolutional neural network N1 corresponding to that unit is determined by Equation 1.

When compared at the same convolutional layer hierarchy, the “image” flowing through the first convolutional neural network N1 and the “image” flowing through the second convolutional neural network N2 are of the same size. Therefore, the convolution setting unit 150 can be said to be overlaying the “image” flowing through the second convolutional neural network N2 onto the “image” flowing through the first convolutional neural network N1, and feeding back the shape information to the analysis of the color information.

The evaluation unit 160 inputs an image to the first convolutional neural network N1 and performs semantic segmentation on the input image. That is, the evaluation unit 160 inputs a second image captured by the imaging unit of the surroundings of the vehicle to the first convolutional neural network N1.

The evaluation unit 160 may obtain a second label that identifies road surface markings appearing in the second image by calculating the output from the first convolutional neural network N1 to which the second image is input.

The evaluation unit 160 may identify road surface markings appearing in the second image by obtaining the second label for each pixel constituting the second image by calculating the output from the first convolutional neural network N1 to which the second image is input.

The imaging unit that captured the second image may be the same as or different from the imaging unit that captured the first image used for generating the learning model. Also, the vehicle having the surroundings where the second image is captured may be the same as or different from the vehicle having the surroundings where the first image is captured.

Additionally, the evaluation unit 160 may output the second label obtained for each pixel constituting the second image to the outside via the output unit 400.

The evaluation unit 160 may also determine whether additional learning is needed to update the first convolutional neural network N1 and the second convolutional neural network N2. More specifically, the evaluation unit 160 may calculate a confusion matrix (TP/TN/FP/FN) between the results estimated for each pixel by the learning model using the teaching label images and the first labels (correct labels) assigned to each pixel in the teaching label images.

Here, TP (true positive) represents the number of correct estimates that it is the correct label. TN (true negative) represents the number of correct estimates that it is not the correct label. FP (false positive) represents the number of incorrect estimates that it is the correct label. FN (false negative) represents the number of incorrect estimates that it is not the correct label.

The evaluation unit 160 may then calculate the accuracy, precision, recall, and F-measure of the learning model based on the confusion matrix. Here, the accuracy of the learning model is calculated by “(TP+TN)/(TP+TN+FP+FN)”. Precision is a metric that measures the extent to which what was estimated to be the correct label was actually the correct label, and is calculated by “TP/(TP+FP)”. Recall is a metric that measures the extent to which what was actually the correct label was estimated to be the correct label, and is calculated by “TP/(TP+FN)”.

The F-measure is calculated as the harmonic mean of precision and recall: “2×precision×recall/(precision+recall)”.

The evaluation unit 160 may specify learning target labels based on the calculated F-measure. The processes at the color information acquisition unit 110, the shape information acquisition unit 120, the first learning unit 130, the second learning unit 140, and the convolution setting unit 150 may be repeatedly executed until a learning model that meets the target estimation accuracy is obtained.

For example, the evaluation unit 160 may calculate the recognition rate for each road surface marking when identifying road surface markings using at least one of the trained first convolutional neural network or the trained second convolutional neural network. The evaluation unit 160 may then extract road surface markings with recognition rates below a predetermined value as target road surface markings. Furthermore, the evaluation unit 160 may extract first images where the number of pixels constituting the target road surface markings is equal to or greater than a predetermined number as target images, and execute the first machine learning and the second machine learning based on the target images.

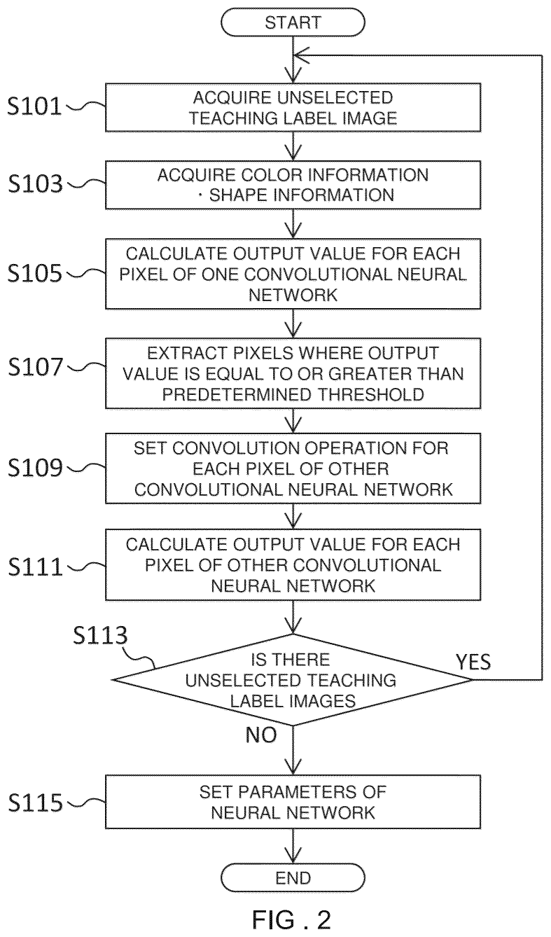

FIG. 2 is a flowchart showing a processing example of the road surface marking identification device according to the present embodiment. The processing of the road surface marking identification device shown in FIG. 2 may be repeatedly executed at predetermined intervals.

In step S101, the acquisition unit 71 acquires an unselected teaching label image as training data.

In step S103, the color information acquisition unit 110 acquires color information for each pixel constituting the first image based on the first image included in the teaching label image. Also, the shape information acquisition unit 120 acquires shape information for each pixel constituting the first image based on the first image included in the teaching label image.

In step S105, the output value for each pixel of one of the first convolutional neural network N1 and the second convolutional neural network N2 is calculated. For example, the first learning unit 130 calculates the output value for each pixel of the first convolutional neural network N1. The second learning unit 140 calculates the output value for each pixel of the second convolutional neural network N2.

In step S107, the convolution setting unit 150 extracts pixels from one convolutional neural network where the output value is equal to or greater than a predetermined threshold.

In step S109, the convolution setting unit 150 sets the convolution operation for each pixel of the other convolutional neural network among the first convolutional neural network N1 and the second convolutional neural network N2.

Specifically, the convolution setting unit 150 sets a “filter” with a filter size of 1 for pixels of the first convolutional neural network N1 corresponding to pixels of the second convolutional neural network N2 where the output value is equal to or greater than the predetermined threshold. On the other hand, the convolution setting unit 150 sets a “filter” with a filter size greater than 1 for pixels of the first convolutional neural network N1 corresponding to pixels of the second convolutional neural network N2 where the output value is less than the predetermined threshold.

Alternatively, the convolution setting unit 150 sets a “filter” with a filter size of 1 for pixels of the second convolutional neural network N2 corresponding to pixels of the first convolutional neural network N1 where the output value is equal to or greater than the predetermined threshold. On the other hand, the convolution setting unit 150 sets a “filter” with a filter size greater than 1 for pixels of the second convolutional neural network N2 corresponding to pixels of the first convolutional neural network N1 where the output value is less than the predetermined threshold.

In step S111, the output value for each pixel of the other convolutional neural network among the first convolutional neural network N1 and the second convolutional neural network N2 is calculated. For example, the second learning unit 140 calculates the output value for each pixel of the second convolutional neural network N2. The first learning unit 130 calculates the output value for each pixel of the first convolutional neural network N1.

In step S113, the controller 100 determines whether there are any unselected teaching label images.

If it is determined that there are unselected teaching label images (if YES in step S113), the process returns to step S101. On the other hand, if it is determined that there are no unselected teaching label images (if NO in step S113), the process proceeds to step S115.

In step S115, the first learning unit 130 sets the parameters of the first convolutional neural network N1 based on the output values of the first convolutional neural network N1. Also, the second learning unit 140 sets the parameters of the second convolutional neural network N2 based on the output values of the second convolutional neural network N2. After that, the processing of the road surface marking identification device shown in FIG. 2 is terminated.

As described in detail above, the road surface marking identification method and the road surface marking identification device according to the present embodiment identify a road surface marking appearing in a first image captured by an imaging unit mounted on a vehicle of surroundings of the vehicle, perform first machine learning using a first convolutional neural network to learn a relationship between color information of the first image and a first label, perform second machine learning using a second convolutional neural network to learn the relationship between shape information of the first image and the first label, select the convolution operation for each pixel constituting the convolutional layer of one of the first convolutional neural network and the second convolutional neural network based on the output value for each pixel constituting the convolutional layer of the other during the first machine learning and the second machine learning, and identify the road surface marking using at least one of the first convolutional neural network and the second convolutional neural network.

This allows the suppression of information loss in elongated regions within the image in the recognition of traffic signs appearing in images using a convolutional neural network, suppresses misrecognition of traffic signs such as unclear traffic signs or distant color-differentiated lanes.

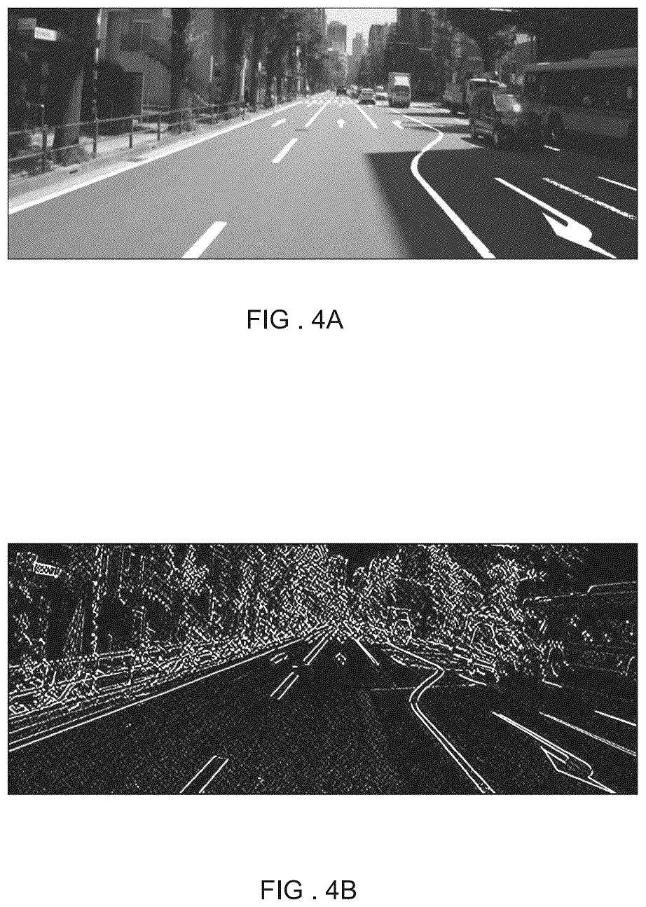

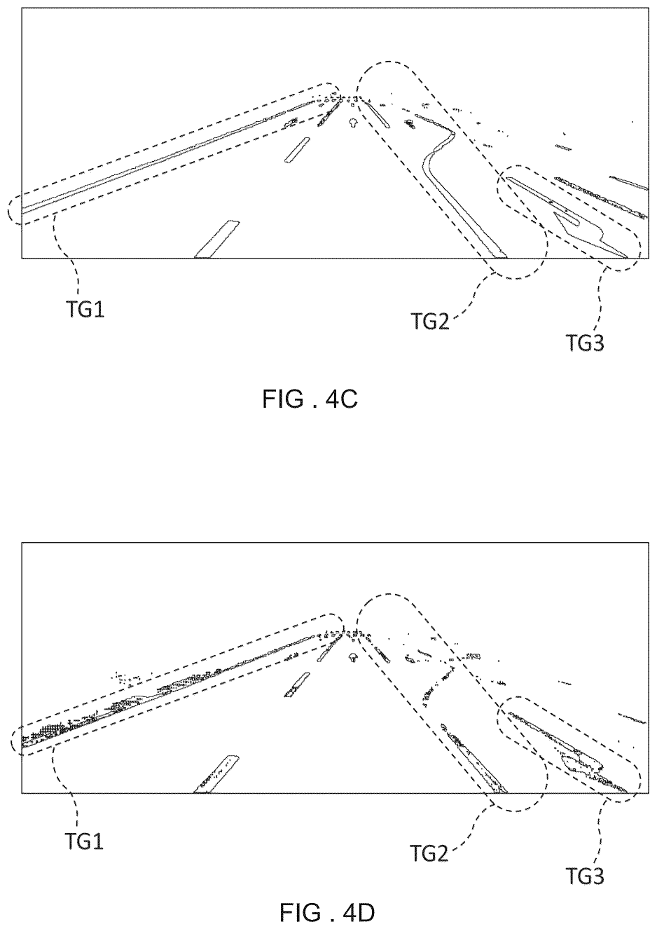

For example, consider the case of performing semantic segmentation on an image captured of the surroundings of a vehicle as shown in FIG. 4A. The road surface marking identification method and road surface marking identification device according to the present embodiment inputs color information obtained for each pixel of the image as shown in FIG. 4A to the first convolutional neural network.

The road surface marking identification method and the road surface marking identification device according to the present embodiment then generate shape information based on the image shown in FIG. 4A. FIG. 4B is a diagram showing an example of shape information generated based on the image shown in FIG. 4A. In FIG. 4B, the outline parts of road surface markings appearing in the image of FIG. 4A are emphasized in white. The road surface marking identification method and the road surface marking identification device according to the present embodiment input shape information obtained for each pixel of the image to the second convolutional neural network.

The result of performing semantic segmentation on an image captured of the surroundings of a vehicle using the road surface marking identification method and the road surface marking identification device according to the present embodiment is shown in FIG. 4C. FIG. 4C is a diagram showing an example of the distribution of labels set for each pixel.

In FIG. 4C, road surface markings TG1 indicating white lines on the side of the road, road surface markings TG2 indicating section lines, and road surface markings TG3 indicating arrows are accurately detected, and labels are set as shown. By using the signals flowing through the second convolutional neural network for selecting convolution operations performed in the first convolutional neural network, shape information is fed back to the analysis of color information. As a result, road surface markings can be accurately detected as shown in FIG. 4C.

For comparison with FIG. 4C, FIG. 4D shows the result when the signals flowing through the second convolutional neural network are not used for selecting convolution operations performed in the first convolutional neural network. FIG. 4D is a diagram showing a reference example of the distribution of labels set for each pixel.

Unlike FIG. 4C, in FIG. 4D, the road surface markings TG1, the section line road surface markings TG2, and the arrow road surface markings TG3 are not accurately detected. This is attributed to information loss at the boundary parts of road surface markings due to the convolution operations performed in the first convolutional neural network.

According to the road surface marking identification method and the road surface marking identification device of the present embodiment, as a result of selecting the convolution operations for each unit constituting the convolutional layer of the first convolutional neural network, information loss at the boundary parts of road surface markings is suppressed, and misrecognition of traffic signs such as unclear traffic signs or distant color-differentiated lanes is suppressed.

Additionally, the road surface marking identification method and the road surface marking identification device according to the present embodiment may perform convolution with a filter size of 1 at pixels of the other convolutional layer corresponding to pixels of one convolutional layer having output values equal to or greater than a predetermined threshold during the first machine learning and the second machine learning. This suppresses information loss at the boundary parts of road surface markings. In particular, since the filter size is 1, blurring of the contour position during convolution is suppressed.

Furthermore, the road surface marking identification method and the road surface marking identification device according to the present embodiment may perform convolution with a filter size greater than 1 at pixels of the other convolutional layer corresponding to pixels of one convolutional layer having output values less than a predetermined threshold during the first machine learning and the second machine learning. This enables capturing the continuity of road surface markings in parts other than the boundaries of road surface markings. As a result, road surface markings appearing in the image can be accurately detected.

Also, in the road surface marking identification method and the road surface marking identification device according to the present embodiment, the shape information may include edge information of road surface markings appearing in the first image. This suppresses information loss at the edge parts of road surface markings.

Furthermore, the road surface marking identification method and the road surface marking identification device according to the present embodiment may generate edge information by applying a Sobel filter to the first image.

This enables accurately capturing the edge parts of road surface markings appearing in the first image, allowing the edge parts to be reflected in machine learning.

Also, in the road surface marking identification method and the road surface marking identification device according to the present embodiment, the shape information may include corner information of road surface markings appearing in the first image. This suppresses information loss at the corner parts of road surface markings.

Furthermore, the road surface marking identification method and the road surface marking identification device according to the present embodiment may generate corner information by applying a Harris filter to the first image. This enables accurately capturing the corner parts of road surface markings appearing in the first image, allowing the corner parts to be reflected in machine learning.

Also, the road surface marking identification method and the road surface marking identification device according to the present embodiment may calculate the recognition rate for each road surface marking when identifying road surface markings using at least one of the trained first convolutional neural network or the trained second convolutional neural network. Road surface markings with recognition rates below a predetermined value may be extracted as target road surface markings. First images where the number of pixels constituting the target road surface markings is equal to or greater than a predetermined number may be extracted as target images. First machine learning and second machine learning may be executed based on the target images.

This enables relearning targeting road surface markings with low recognition rates. In particular, by extracting and using images containing many pixels related to road surface markings with low recognition rates for first machine learning and second machine learning, the efficiency of relearning is improved.

The functions shown in the above embodiments can be implemented by one or more processing circuits. Processing circuits may include programmed processors, electrical circuits, and also devices such as application-specific integrated circuits (ASICs) or circuit configuration elements arranged to perform the described functions.

While the content of the present invention has been described according to the embodiments, it is obvious to those skilled in the art that the present invention is not limited to these descriptions and that various modifications and improvements are possible. The discussions and drawings forming part of this disclosure should not be understood as limiting the present invention. Various alternative embodiments, examples, and operational techniques will be apparent to those skilled in the art from this disclosure.

Of course, the present invention includes various embodiments not described herein. Therefore, the technical scope of the present invention is defined only by the invention-specific matters in the appropriate scope of patent claims based on the above description.

1. A road surface marking identification method for controlling a controller that identifies a road surface marking appearing in a first image captured by an imager mounted on a vehicle of surroundings of the vehicle, wherein
the controller:
acquires color information and shape information for each pixel constituting the first image based on the first image;
performs first machine learning using a first convolutional neural network consisting of multiple convolutional layers, so that, for each pixel, a first label identifying the road surface marking is output from the first convolutional neural network to which the color information is input;
performs second machine learning using a second convolutional neural network consisting of multiple convolutional layers, having the same number of convolutional layers and the same size of each convolutional layer as the first convolutional neural network, so that, for each pixel, the first label is output from the second convolutional neural network to which the shape information is input;
during the first machine learning and the second machine learning, selects the convolution operation for each pixel constituting the convolutional layer of the other of the first convolutional neural network and the second convolutional neural network based on the output value for each pixel constituting the convolutional layer of one of the first convolutional neural network and the second convolutional neural network; and
identifies the road surface marking using at least one of a trained first convolutional neural network with parameters adjusted based on the first machine learning or a trained second convolutional neural network with parameters adjusted based on the second machine learning.

2. The road surface marking identification method according to claim 1, wherein the controller,
during the first machine learning and the second machine learning, performs convolution with a filter size of 1 at pixels of the other convolutional layer corresponding to pixels of the one convolutional layer having output values equal to or greater than a predetermined threshold.

3. The road surface marking identification method according to claim 1, wherein the controller,
during the first machine learning and the second machine learning, performs convolution with a filter size greater than 1 at pixels of the other convolutional layer corresponding to pixels of the one convolutional layer having output values less than a predetermined threshold.

4. The road surface marking identification method according to claim 1, wherein
the shape information includes edge information of the road surface marking appearing in the first image.

5. The road surface marking identification method according to claim 1, wherein
the shape information includes corner information of the road surface marking appearing in the first image.

6. The road surface marking identification method according to claim 1, wherein the controller:
calculates a recognition rate for each road surface marking when identifying the road surface marking using at least one of the trained first convolutional neural network or the trained second convolutional neural network;
extracts a road surface marking with recognition rates below a predetermined value as the target road surface marking;
extracts the first image where the number of pixels constituting the target road surface marking is equal to or greater than a predetermined number as a target image; and
executes the first machine learning and the second machine learning based on the target image.

7. A road surface marking identification device comprising:
a controller that identifies a road surface marking appearing in a first image captured by an imager mounted on a vehicle of surroundings of the vehicle, wherein
the controller:
acquires color information and shape information for each pixel constituting the first image based on the first image;
performs first machine learning using a first convolutional neural network consisting of multiple convolutional layers, so that, for each pixel, a first label identifying the road surface marking is output from the first convolutional neural network to which the color information is input;
performs second machine learning using a second convolutional neural network consisting of multiple convolutional layers, having the same number of convolutional layers and the same size of each convolutional layer as the first convolutional neural network, so that, for each pixel, the first label is output from the second convolutional neural network to which the shape information is input;
during the first machine learning and the second machine learning, selects the convolution operation for each pixel constituting the convolutional layer of the other of the first convolutional neural network and the second convolutional neural network based on the output value for each pixel constituting the convolutional layer of one of the first convolutional neural network and the second convolutional neural network; and
identifies the road surface marking using at least one of a trained first convolutional neural network with parameters adjusted based on the first machine learning or a trained second convolutional neural network with parameters adjusted based on the second machine learning.
